(19) United States
(12) Patent Application Publication
(10) Pub. No.: US 2007/0113970 A1
(43) Pub. Date: May 24, 2007

(54) Process for the manufacturing of decorative laminate

(75) Inventors: Krister Hansson, Vellinge (SE); Kent Lindgren, Perstorp (SE)

Correspondence Address: STEVENS DAVIS MILLER & MOSHER, LLP, 1615 L STREET, NW, SUITE 850, WASHINGTON, DC, 20036, US

(73) Assignee: Pergo (Europe) AB, Trelleborg (SE)

(21) Appl. No.: 10/580,219

(22) PCT Filed: Nov. 24, 2004
(86) PCT No.: PCT/SE04/01723

§ 371 Date: Jun. 28, 2006

(30) Foreign Application Priority Data
Nov. 25, 2003 (SE) 0303148-1

(51) Int. Cl. B32B 37/00

(52) U.S. Cl. 156/277; 156/331.3

(57) ABSTRACT

A process for the manufacturing of a decorative laminate having a base layer, a decorative layer and a wear layer wherein a decor is printed on a base layer. The decor printed comprises a printing ink and the wear layer comprises a thermosetting resin selected from the group consisting of melamine-formaldehyde resin, phenol-formaldehyde resin, urea formaldehyde and mixtures thereof. An amount of amino resin is mixed into the printing ink in order to increase the bond between the decorative layer and the wear layer. The layers are laminated together in a laminate press under increased temperature and pressure.

The present invention relates to a process for the manufacturing of a decorative laminate with increased laminar bond.

Products clad with thermosetting laminate is common in many areas nowadays. They are mostly used where the demands on abrasion resistance are high, and furthermore where resistance to different chemicals and moisture is desired. As examples of such products floors, floor skirting, table tops, work tops and wall panels can be mentioned.

The thermosetting laminate most often consist of a number of base sheets with a decor sheet placed closest to the surface. The decor sheet can be provided with a pattern by desire. Common patterns usually visualise different kinds of wood or mineral such as marble and granite.

The substrate carrying the decor often consist of a cellulose sheet on which the decor is printed. It is also known to use polymeric or polymer/cellulose blend materials as a decor carrier on which the decor is printed. The decor sheet will need some protection and it is known to use one or more layers of cellulose impregnated with thermosetting resin arranged on top of the decor layer. It is known that the printing ink itself sometimes will cause problems with de-lamination, especially when certain pigments, solvents and amounts of ink is used. This is a problem which sometimes occur after some time of use.

It has, through the present invention, been made possible to overcome the above mentioned problems and a decorative laminate where the bond between decor layer and supporting layers is increased has been obtained. The invention relates to a process for the manufacturing of a decorative laminate having a base layer, a decorative layer and a wear layer. A decor is printed on a base layer wherein the decor printed comprises a printing ink. The wear layer comprises a thermosetting resin selected from the group consisting of; melamine-formaldehyde resin, phenol-formaldehyde resin, urea formaldehyde resin and mixtures thereof. The invention is characterised in that an amount of amino resin is mixed into the printing ink in order to increase the bond between the decorative layer and the wear layer. The layers are then laminated together in a laminate press under increased temperature and pressure. The printing ink is suitably an alkyde based ink or a polyester-acrylate based ink. The amino resin added to the ink is preferably an etherified amino resin or a methylol amino resin.

The base layer may, according to one embodiment of the invention, be manufactured in the desired end user format and provided with edges intended for joining before applying decor and wear layer. A main part of the base layer is suitably constituted by a particle board or a fibre board. It is advantageous to provide the base layer with a paper layer on which the decor is printed. This paper layer is suitably bonded to the base layer prior to the printing of the decor.

The wear layer is, according to one embodiment of the invention comprised of a high viscosity amino resin applied on top of the decorative layer prior to the lamination. According to another embodiment of the invention the wear layer is comprised of an amino resin/cellulose mixture. According to yet another embodiment of the invention the wear layer is comprised of one or more amino resin impregnated cellulose layer or layers.

In order to increase the abrasion resistance it is advantageous to add hard particles with an average particle size in the range 50 nm-150 μm to the wear layer. In order to increase both scratch resistance and wear resistance the wear layer is suitably provided with hard particles with an average particle size in the range 50 nm-30 μm while the inner portion of the wear layer is provided with hard particles with an average particle size in the range 31 μm-150 μm. The hard particles is preferably constituted by silicon oxide, silicon carbide, aluminium oxide or the like.

The wear layer is suitably provided with a surface structure that enhances the realistic impression of the decor during or after the lamination. This is suitably achieved by any known method of embossing.

According to one embodiment of the invention the decor is achieved by digitisation of an actual archetype or by partly or completely being created in a digital media. The digitised decor is stored digitally in order to be used as a control function and original, together with possible control programs, when printing the decor.

The decor may accordingly be obtained by making a high resolution or selected resolution digital picture of the desired decor. This is suitably made by means of a digital camera or scanner. The most common decor will of course be different kinds of wood and minerals like marble, as these probably will continue to be preferred surface decoration in home and public environments. It is, however, possible to depict anything that is visible. The digitised version of the decor is then edited to fit the size of the supporting core. It is also possible to rearrange the decor in many different ways, like changing colour tones, contrast, dividing the decor into smaller segments and adding other decorative elements. It is also possible to completely create the decor in a computer equipped for graphic design. It is possible to create a simulated decor so realistic that even a professional will have great problems in visually separating it from genuine material. This makes it possible to make for example floor boards with an almost perfect illusion of a rare kind of wood, like ebony or rose wood and still preserving trees under threat of extermination.

The digital decor is used together with guiding programs to control a printer. The printer may be of an electrostatic type or an ink-jet type printer. Most often the colours yellow, magenta, cyan and black will be sufficient for the printing process, but in some cases it might be advantageous to add white. Some colours are difficult to achieve using the colours yellow, magenta, cyan, black and white whereby the colours light magenta and light cyan may be added. It is also possible to add so called spot colours where specific colour tones are difficult to achieve or where only certain parts of the colour spectrum with intermixing shades is desired. The resolution needed is much depending on the decor that is to be simulated, but resolutions of 10-1500 dots per inch (dpi) is the practical range in which most decors will be printed. Under normal conditions a resolution of 300-800 dpi is sufficient when creating simulations of even very complex decorative patterns and still achieve a result that visually is very difficult to separate from the archetype without close and thorough inspection.

It is advantageous to manufacture the supporting core in the desired end user format and to provide it with edges suited for joining before applying the decor and wear layer, since the amount of waste thereby is radically reduced. The decor matching tolerances will also be improved further by this procedure.

As mentioned above the translucent wear layer is suitably constituted of melamine-formaldehyde resin/cellulose blend, high viscosity melamine-formaldehyde or one or more sheets of cellulose which are impregnated with melamine-formaldehyde resin. This wear layer is joined with the core and decor under heat and pressure whereby the resin cures. It is advantageous to add hard particles with an average particle size in the range 50 nm-150 μm to the wear layer. Larger particles, in the range 10 μm-150 μm, preferably 30 μm-150 μm is foremost used to achieve abrasion resistance while the smaller of the particles, in the range 50 nm-30 μm, preferably 50 nm-10 μm, is used to achieve scratch resistance. The smaller particles is hereby used on, or very close to, the top surface while the larger particles may be distributed in the wear layer. Also here the particles advantageously are constituted of silicon carbide, silicon oxide, aluminium oxide. The wear layer is hereby suitably pressed together with the rest of the decorative laminate in a continuos belt press with two steel belts. It is also possible to utilise a discontinuous process where one or a number of surface elements can be pressed at the same time.

1. A process for the manufacturing of a decorative laminate having a base layer, a decorative layer and a wear layer wherein a decor is printed on a base layer wherein the decor printed comprises a printing ink and wherein the wear layer comprises a thermosetting resin selected from the group consisting of melamine-formaldehyde resin, phenol-formaldehyde resin, urea formaldehyde resin and mixtures thereof, whereby an amount of amino resin is mixed into the printing ink in order to increase the bond between the decorative layer and the wear layer whereby the layers are laminated together in a laminate press under increased temperature and pressure.

2. A process according to claim 1 wherein the printing ink is an alkyde based ink.

3. A process according to claim 1 wherein the printing ink is a polyester-acrylate based ink.

4. A process according to claim 2 wherein the amino resin is an etherified amino resin.

5. A process according to claim 2 wherein the amino resin is a methylol amino resin.

6. A process according to claim 1 wherein the base layer is manufactured in the desired end user format and provided with edges intended for joining before applying decor and wear layer.

7. A process according to claim 6 wherein the main part of the base layer is constituted by a particle board.

8. A process according to claim 6 wherein the base layer is provided with a paper layer on which the decor is printed.

9. A process according to claim 8 wherein the paper layer is bonded to the base layer prior to the printing of the decor.

10. A process according to claim 1 wherein the wear layer is comprised of a high viscosity amino resin applied on top of the decorative layer prior to the lamination.

11. A process according to claim 1 wherein the wear layer is comprised of an amino resin/cellulose mixture.

12. A process according to claim 1 wherein the wear layer is comprised of one or more amino resin impregnated cellulose layer or layers.

13. A process according to claim 10 wherein the wear layer also comprises hard particles with an average particle size in the range 50 nm-150 μm.

14. A process according to claim 13 wherein the upper portion of the wear layer is provided with hard particles with an average particle size in the range 50 nm-30 μm while the inner portion of the wear layer is provided with hard particles with an average particle size in the range 31 μm-150 μm.

15. A process according to claim 13 wherein the hard particles are at least one selected from the group consisting of silicon oxide, silicon carbide and aluminium oxide.

16. A process according to claim 1 wherein the wear layer is provided with a surface structure that enhances the realistic impression of the decor during or after the lamination.

17. A process according to claim 6 wherein the main part of the base layer comprises fibre board.
